(19) United States
(12) Patent Application Publication
(10) Pub. No.: US 2014/0288970 A1
(43) Pub. Date: Sep. 25, 2014

(54) IDENTIFYING RELEVANT IMAGING EXAMINATION RECOMMENDATIONS FOR A PATIENT FROM PRIOR MEDICAL REPORTS OF THE PATIENT TO FACILITATE DETERMINING A FOLLOW UP IMAGING EXAMINATION(S) FOR THE PATIENT

(71) Applicants: Michael Chun-chieh Lee, Lexington, MA (US); Yuechen Qian, Briarcliff Manor, NY (US); James Chi-Kuei Shaw, Tenafly, NJ (US)

(72) Inventors: Michael Chun-chieh Lee, Lexington, MA (US); Yuechen Qian, Briarcliff Manor, NY (US); James Chi-Kuei Shaw, Tenafly, NJ (US)

(73) Assignee: KONINKLIJKE PHILIPS N.V., Eindhoven (NL)

(21) Appl. No.: 14/220,418

(22) Filed: Mar. 20, 2014

Related U.S. Application Data
(60) Provisional application No. 61/803,484, filed on Mar. 20, 2013.

(51) Int. Cl. G06F 19/00

(52) U.S. Cl. CPC G06F 19/322
USPC 705/3; 705/2

(57) ABSTRACT

A method for identifying relevant follow-up recommendations from medical reports includes identifying with a processor follow-up recommendations in electronically formatted prior medical reports, and visually presenting, via a display monitor, the identified follow-up recommendations. A computing apparatus (102) including a processor that obtains, in electronic format, an imaging examination order for a follow-up imaging examination of a patient, wherein the imaging examination order at least includes a unique identification of the patient, retrieves electronically formatted prior medical reports of the patient from a data repository based on the patient or the unique identification of the patient, identifies follow-up imaging recommendations in the retrieved electronically formatted prior medical reports, and visually presents the identified follow-up imaging recommendations.

The following generally relates to identifying relevant imaging examination recommendations for a patient from prior medical reports of the patient to facilitate determining a follow-up imaging examination(s) for the patient.

In the standard workflow, an imaging order (ordered by a ‘referring physician’) is received by a radiology department or imaging center. The order typically describes the general type of examination. For example, the order may indicate a computer tomography (CT), a magnetic resonance imaging (MRI), a positron emission tomography (PET), a single photon emission tomography (SPECT), an ultrasound (US), and/or other scan of the subject. The order typically also describes the anatomy to be scanned (e.g., head, chest, foot etc.) and provides some indication of the reason for the scan (e.g., headaches and/or vomiting, labored breathing, rule out broken bone, etc.).

A radiologist or technologist reviews the order and assigns a clinical imaging protocol from a plurality of available pre-defined scan protocols. In many cases, a subject is returning for a follow-up imaging examination. In these instances, the choice of protocol is improved when the prior radiology reports (or other reports) are available for review by the person doing the protocoling. In many cases, these reports provide direct guidance on the specific type of imaging examination to be performed. In other cases, the reports provide indirect information by identifying the specific reason why the follow-up examination was scheduled. Examples of this type of information include: “CTA is recommended in order to . . . ” or “Additional imaging with MRI may distinguish . . . ” or “Follow-up imaging is recommended.”

Unfortunately, manual review of prior reports by a radiologist or technologist in search of follow-up recommendations can be time-consuming and prone to radiologist or technologist error. Often, these prior reports are not consulted at all during protocoling, in part due to the fact that reviewing them may take excessive time. Therefore, there is an unresolved need for other approaches for leveraging the follow-up recommendations in prior reports.

Aspects described herein address the above-referenced problems and others.

In one aspect, a method for identifying relevant follow-up recommendations from medical reports includes identifying, with a processor, follow-up recommendations in electronically formatted prior medical reports, and visually presenting, via a display monitor, the identified follow-up recommendations.

In another aspect, a computing apparatus includes a processor, which executes the computer executable instructions. The processor, when executing the computer executable instructions: obtains, in electronic format, an imaging examination order for a follow-up imaging examination of a patient, wherein the imaging examination order at least includes one or more of a name of the patient or a unique identification of the patient, retrieves electronically formatted prior medical reports of the patient from a data repository based on the one or more of the name of the patient or the unique identification of the patient, identifies follow-up imaging recommendations in the retrieved electronically formatted prior medical reports, and visually presents the identified follow-up imaging recommendations.

In another aspect, a computer readable storage medium encoded with computer readable instructions, which, when executed by a processer, causes the processor to: obtain, in electronic format, an imaging examination order for a follow-up imaging examination of a patient, wherein the imaging examination order at least includes one or more of a name of the patient or a unique identification of the patient, retrieve electronically formatted prior medical reports of the patient from a data repository based on the one or more of the name of the patient or the unique identification of the patient, identify follow-up imaging recommendations in the retrieved electronically formatted prior medical reports, visually present the identified follow-up imaging recommendations.

The invention may take form in various components and arrangements of components, and in various steps and arrangements of steps. The drawings are only for purposes of illustrating the preferred embodiments and are not to be construed as limiting the invention.

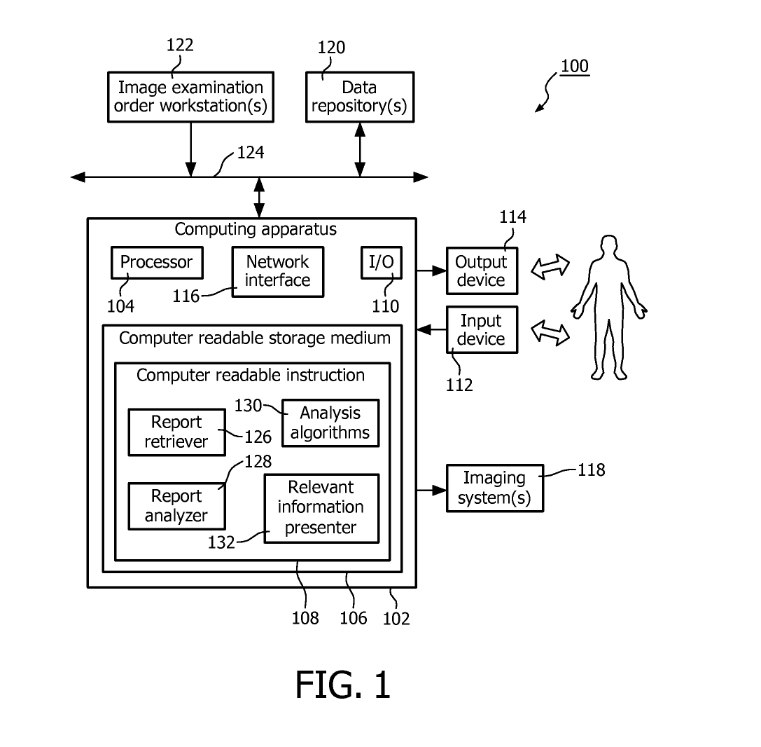

FIG. 1 schematically illustrates a system for identifying relevant follow-up imaging examination recommendations from medical reports.

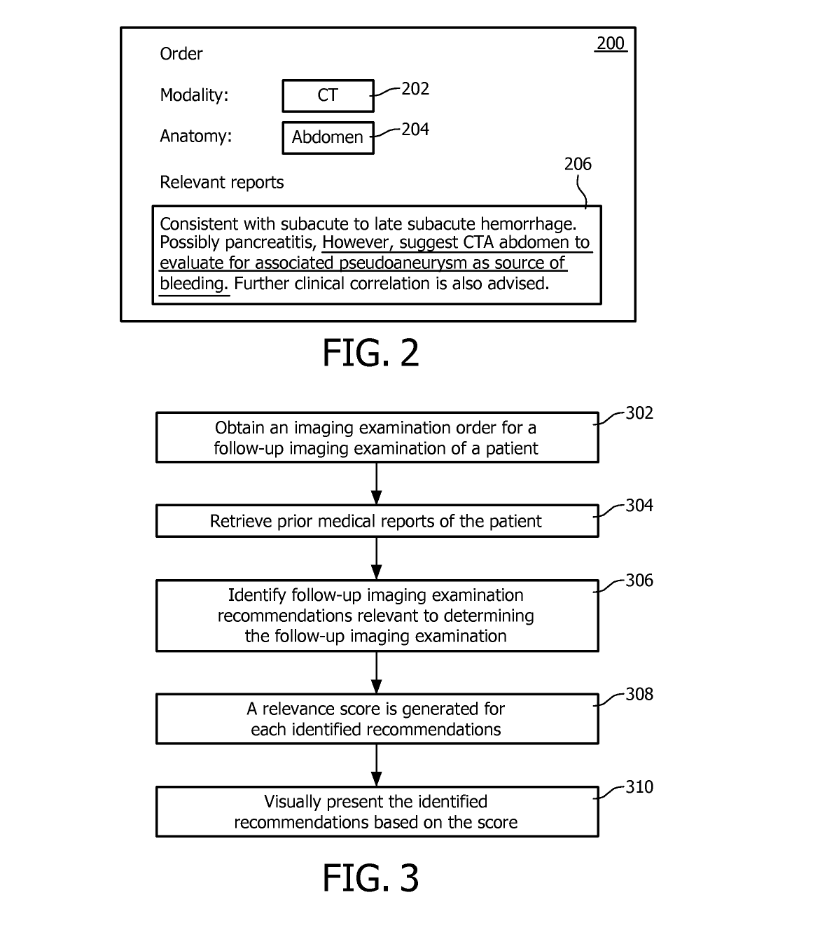

FIG. 2 illustrates an example presentation of identified relevant follow-up imaging examination recommendations.

FIG. 3 illustrates an example method for identifying relevant follow-up imaging examination recommendations from medical reports.

FIG. 1 illustrates a system 100 in which a computing apparatus 102 identifies relevant follow-up imaging examination recommendations for a patient from archived imaging reports of the patient and visually presents the identified imaging examinations, which can be used to guide a radiologist or technician with determining a suitable follow-up imaging examination for the patient and thereby reduce the amount of time and effort involved with determining a suitable follow-up imaging examination.

In many cases, a prior medical (e.g., a radiology) report will indicate that a follow-up imaging examination should be performed for a specific clinical purpose or to evaluate a clinical hypothesis. Moreover, in some instances, a preferred imaging approach, i.e. scan modality and scan protocol, is explicitly identified in the prior report. When the patient returns for the follow-up examination, this prior report information may be of importance to the radiologist or technologist planning the follow-up examination. The computing apparatus 102 mines and presents such information.

The computing apparatus 102 includes at least one processor 104 that executes one or more computer readable instructions 106 stored in computer readable storage medium 108, such as physical memory or other non-transitory storage medium. Optionally, the processor 104 can additionally or alternatively execute one or more computer readable instructions carried by a carrier wave, a signal or other transitory medium.

The computing apparatus 102 further includes input/output (I/O) 110, which is configured to receive information from one or more input devices 112 such as a keyboard, a mouse, etc. and/or convey information to one or more output devised 114 such as one or more display monitors. A network interface 116 allows the computing apparatus 102 to communicate with other devices such as an imaging system(s) 118, a data repository(s) 120, and/or an image examination order workstation(s) 122 via a network 124.

Examples of imaging systems include, but are not limited to, a computed tomography (CT), a magnetic resonance (MR), a positron emission tomography (PET), a single photon emission computed tomography (SPECT), an ultrasound (US), and an X-ray imaging system. Examples data repositories 120 include, but are not limited to, a picture archiving and communication system (PACS), a radiology information system (RIS), a hospital information system (HIS), and an electronic medical record (EMR).

The image examination order workstation(s) 122 can be a general purpose computer or the like located at a physician's office. The image examination order workstation(s) 122 at least includes software that allows personnel at the physician's office to electronically order an imaging examination for a patient. The image examination order workstation(s) 122 packages and transmits an order to the computing apparatus 102 using a format such as Health Level Seven (HL7), Extensible Markup Language (XML), Digital Imaging and Communications in Medicine (DICOM), or combinations thereof, and/or other format.

Generally, such an order will include the patient's name and/or unique identification (UID) and information about the requested imaging examination. Such information typically also includes the modality (CT, MR, PET, SPECT, US, X-ray, etc.) and the anatomy (e.g., head, chest, pelvis, etc.). Other information may include a contrast agent and/or a requested/scheduled scan date. An order for a patient may be sent to the computing apparatus 102 in response to the workstation(s) 122 receiving a request for the order by the the computing apparatus 102 and/or for submission via a user of the workstation(s) 122.

The one or more computer readable instructions 106 include instructions for implementing a report retriever 126, a report analyzer 128, at least one analysis algorithm 130, and a relevant information presenter 132.

The report retriever 126 obtains the patient's name and/or unique identification (UID) from an imaging examination order received from the image examination order workstation(s) 122 and/or other device. The report retriever 126 employs this information to query the data repository(s) 120 for medical reports of the patient. Such reports include radiology reports and, optionally, pathology reports, office notes, emergency room reports, discharge summaries, surgical reports, endoscopy reports, etc.

A medical report is formatted in any computer-interpretable format and retrieved through standard or proprietary interfaces such as HL7 messages, direct queries to a database, queries to an EMR or PACS, etc. A medical report for a patient may be sent to the computing apparatus 102 in response to a request by the report retriever 126 for the medical report and/or the data repository(s) 120 pushing medical reports to the computing apparatus 102.

The report analyzer 128 analyses received medical reports based on one or more of the analysis algorithms 130. Generally, the report analyzer 128 analyses received medical reports and identifies fragments of text in the medical reports that include a relevant follow-up imaging examination recommendation or (other relevant information about follow-up examinations) for determining a suitable follow-up imaging examination.

By way of non-limiting example, the report analyzer 128 segments the text of a medical report into sentences, for example, by breaking at punctuation. In an alternate example, the “sentence” is replaced with a sliding window of a fixed or variable size, measured in number of words. The words in each sentence are stemmed (i.e. reduced to their base/root grammatical form), for example, by using a look-up table of standard English word endings and variants. Other methods for stemming are also contemplated herein.

From the stemmed words, N-grams (where N is an integer greater than one (1)) are computed, describing the occurrence of words in sequence within each sentence, and N-grams are stored in a vector. For example, a 3-gram (trigram) calculation may create a binary vector showing the occurrence (e.g., value of one (1)) or non-occurrence (e.g., value of zero (0)) of triplets of words such as “MRI is suggest*” or “may be help*” or “followup is recommend*”,where the asterisks “*” is a consequence of the stemming.

The vector is processed via one or more mathematical functions (e.g., a classifier) to produce a score, which in one example is a real-valued number between 0 and 1, where 0 indicates that the processed sentence or set of words does not contain a recommendation, 1 indicates that it does, and intermediate values between 0 and 1 indicate varying degrees of probability that the text contains a recommendation. The mathematical functions may have parameters computed by a support vector machine (SVM), Bayesian network, neural network, linear discriminant classifier, decision tree, nearest neighbour classifier, or ensemble thereof.

The report analyzer 128 identifies text as including relevant follow-up imaging examination recommendations based on the score and a predetermined relevance threshold.

Optionally, the report analyser 128 filters the relevant follow-up imaging examination recommendations to ensure that they are related to the requested procedure (scan modality and details) and anatomy. For example, in one embodiment, the report analyser 128 searches a relevant follow-up imaging examination recommendation, optionally augmented with a given window around the candidate sentences (e.g. one sentence before and after) for key contextual terms, such as the scan modality and anatomy. These are checked for matches against the current imaging examination order. The presence of the appropriate context is used to modulate the score associated with the sentence.

For example, detecting that the modality is mentioned in a previous sentence may increase the score of a sentence; detection of other modalities/anatomies may down-weight the score. By way of further example, where a candidate sentence includes: “Follow-up is recommended with thin-slice CT of the cervical spine,” and the imaging examination order is for an MRI scan of the abdomen, the score would be weighted down because although the information is correctly identified as relevant for a follow-up, the filtering detects that it is not relevant for this particular follow-up.

Optionally, the report analyser 128 searches text surrounding a relevant follow-up imaging examination recommendation for ontologically related terms and compares the terms with the imaging examination order. If no ontologically related terms are found, the report analyser 128 can remove the identified follow-up imaging recommendation as a relevant recommendation. However, if an ontologically related term is found, the report analyser 128 can confirm a relevance of the identified follow-up imaging recommendation. In addition, the report analyser 128 can increase or decrease the score based thereon.

By way of non-limiting example, for a situation where the imaging examination order is for an “MRI brain,” a candidate relevant sentence notes “MRI follow-up may be helpful,” and the preceding sentence reads “The lesion in the thalamus may represent a malignant process,” an ontological comparison may reveal that “thalamus” is a sub-part of the “brain”, and thus indeed this pair of sentences may be not only relevant to follow-up in general, but relevant to the current follow-up examination. In this case, the score may be increased.

Optionally, the report analyser 128 compares a context of an identified follow-up imaging recommendation with a clinical indication included in the imaging examination order. If a match is not found, the report analyser 128 can remove the identified follow-up imaging recommendation as a relevant recommendation. If a match is found, the report analyser 128 can confirm the identified follow-up imaging recommendation as a relevant recommendation. In addition, the report analyser 128 can increase or decrease the score based thereon. By way of non-limiting example, where the imaging examination order notes that the current exam is for “Tumor evaluation,” the candidate sentence and surrounding region are searched for context by looking for terms related to cancer.

Optionally, the report analyser 128 filters the identified follow-up imaging recommendation to remove identified follow-up imaging recommendation which have already led to subsequent imaging examinations. Such sentences can be labelled as already satisfied and/or no longer relevant and removed from the list of identified follow-up imaging recommendations.

Prior to employing the algorithm 130, or the mathematical function in this example, the parameters for the classification function may be generated through a training framework, wherein stemming and computing the N-grams are repeated on a set of sentences which have been labelled as being relevant or non-relevant. Training allows for “learning” appropriate parameters such that the resulting function, when applied to the vector, results in a score related to the likelihood that the underlying sentence contains a recommendation relevant to the follow-up examination. For example, where N-grams such as “MRI is suggest*”, “followup is recommend*”, “would be help*” and the like tend to be seen in sentences of interest, the classifier function would tend to add weight to these n-grams such that their existence in a sentence increases the score of the sentence.

The relevant information presenter 132 visually presents results of the analysis. This includes presenting relevant follow-up imaging examination recommendations that satisfy a predetermined scoring threshold in a list or by highlighting the relevant follow-up imaging examination recommendation within the full text of the reports. The threshold may be default or user configurable.

Optionally, the neighbouring context may also be identified by displaying in the list or highlighting. Optionally, the scores are also displayed. FIG. 2 shows a non-limiting example of visually presented information 200. In this example, the information 200 includes a modality in a modality field 202, an anatomy in an anatomy field 204, and the identified relevant follow-up imaging examination recommendations in a relevant information window 206.

FIG. 3 illustrates an example method for identifying relevant follow-up imaging examination recommendations from medical reports.

It is to be appreciated that the ordering of the acts in the methods described herein is not limiting. As such, other orderings are contemplated herein. In addition, one or more acts may be omitted and/or one or more additional acts may be included.

At 302, an imaging examination order, in electronic format, for a follow-up imaging examination for a patient is obtained by the computing system 102.

At 304, the computing system 102 retrieves electronically formatted prior medical reports of the patient from the data repository 120.

At 306, the computing system 102 analyzes the medical reports and identifies imaging examination recommendations relevant to determining the follow-up imaging examination.

At 308, the computing system 102 generates a relevance score for the information identified as relevant.

At 310, the computing system 102 visually presents the information identified as relevant based on the score.

Optionally, the computing system 102 also visually presents the scores with the visually presented relevant information.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for identifying relevant follow-up recommendations from medical reports, comprising:
identifying, with a processor, follow-up recommendations in electronically formatted prior medical reports; and
visually presenting, via a display monitor, the identified follow-up recommendations.

2. The method of claim 1, further comprising:
obtaining, in electronic format, an imaging examination order for a follow-up imaging examination of a patient, wherein the imaging examination order at least includes one or more of a name of the patient or a unique identification of the patient; and
retrieving electronically formatted prior medical reports of the patient from a data repository based on the one or more of the name of the patient or the unique identification of the patient,
wherein the processor identifies the follow-up recommendations from the retrieved electronically formatted prior medical reports.

3. The method of any of claims 1 to 2, wherein the follow-up recommendations include at least one of imaging recommendations or biopsy recommendations.

4. The method of any of claims 1 to 3, further comprising:
determining a relevance score for each of the identified follow-up recommendations; and
visually presenting a relevance score along with the corresponding identified follow-up recommendation.

5. The method of claim 4, further comprising:
comparing the relevance scores with a predetermined relevance threshold;
identifying the follow-up recommendations that satisfy the predetermined relevance threshold; and
visually presenting only the identified follow-up recommendations satisfying the predetermined relevance threshold,
wherein the identified follow-up recommendations satisfying the predetermined relevance threshold is a subset of the identified follow-up recommendations.

6. The method of claim 5, further comprising:
comparing the relevance scores with a predetermined relevance threshold;
identifying the follow-up imaging recommendations that satisfy the predetermined relevance threshold; and
visually highlighting the identified follow-up recommendations satisfying the predetermined relevance threshold,
wherein the identified follow-up recommendations satisfying the predetermined relevance threshold is a subset of the identified follow-up recommendations.

7. The method of any of claims 5 to 6, wherein identifying the follow-up recommendations, comprises:
identifying fragments of text in the medical reports that present recommendations about follow-up examinations.

8. The method of claim 7, wherein identifying fragments of text, comprises:
segmenting the text into sentences by breaking at punctuation;
stemming each sentence by reducing each sentence to its base/root grammatical form using a look-up table of standard English word endings and variants.

9. The method of claim 6, wherein identifying fragments of text, comprises:
segmenting the text into segments using a sliding window of a predetermined size, measured in a number of words;
stemming each segment by reducing each sentence to its base/root grammatical form using a look-up table of standard English word endings and variants.

10. The method of any of claims 8 to 9, further comprising:
from the stemmed words, computing multiple-grams, each describing an occurrence of words in sequence within each sentence; and
generating a vector of the multiple-grams.

11. The method of claim 10, wherein the vector is a binary vector in which an occurrence of a phrase is assigned a value of one and a non-occurrence of the phrase is assigned a value of zero, and further comprising:
processing the vector with a mathematical function and generating a corresponding relevance score indicative of a likelihood that the sentence described by the vector contains a recommendation relevant to the follow-up examination.

12. The method of claim 11, wherein the mathematical functions is a classifier and includes parameters computed by at least one of a support vector machine, a Bayesian network, a neural network, a linear discriminant classifier, a decision tree, a nearest neighbour classifier, or an ensemble thereof.

13. The method of claims 11, further comprising:
prior to employing the mathematical function, determining the parameters through a training framework in which stemming and computing the multiple-grams are repeated on a set of sentences which are labelled as being relevant or non-relevant.

14. The method of any of claims 5 to 12, further comprising:
filtering the identified follow-up recommendations satisfying the predetermined relevance threshold based on at least one of a requested imaging procedure or an anatomy to be scanned to remove identified follow-up recommendations that do not include the at least one of a requested imaging procedure or an anatomy to be scanned.

15. The method of any of claims 5 to 14, further comprising:
searching text surrounding an identified follow-up recommendation satisfying the predetermined relevance threshold for ontologically related terms;
removing identified follow-up recommendation in response to not finding any ontologically related terms; and
confirming a relevance of the identified follow-up recommendation in response to finding an ontologically related term.

16. The method of any of claims 5 to 14, further comprising:
comparing a clinical indication included on the imaging examination order with a context of an identified follow-up recommendation satisfying the predetermined relevance threshold; and
removing identified follow-up recommendation in response to not finding a match between the clinical indication and the context; and
confirming a relevance of the identified follow-up recommendation in response to finding a match between the clinical indication and the context.

17. The method of any of claims 5 to 16, further comprising:
filtering the identified follow-up recommendation to remove identified follow-up recommendation which have already been carried out.

18. A computing apparatus (102), comprising:
a processor (104), which executes the computer executable instructions, wherein the processor, when executing the computer executable instructions:
obtains, in electronic format, an imaging examination order for a follow-up imaging examination of a patient, wherein the imaging examination order at least includes a unique identification of the patient;
retrieves electronically formatted prior medical reports of the patient from a data repository based on the patient or the unique identification of the patient;
identifies follow-up imaging recommendations in the retrieved electronically formatted prior medical reports; and
visually presents the identified follow-up imaging recommendations.

19. The computing apparatus of claim 18, wherein the processor, when executing the computer executable instructions:
determines a relevance score for each of the identified follow-up imaging recommendations; and
visually presents a relevance score along with the corresponding identified follow-up imaging recommendation.

20. The computing apparatus of claim 19, wherein the processor, when executing the computer executable instructions:
compares the relevance scores with a predetermined relevance threshold;
identifies the follow-up imaging recommendations that satisfy the predetermined relevance threshold; and
visually presents only the identified follow-up imaging recommendations satisfying the predetermined relevance threshold,
wherein the identified follow-up imaging recommendations satisfying the predetermined relevance threshold is a subset of the identified follow-up imaging recommendations.

21. The computing apparatus of claim 20, wherein the processor identifies the follow-up imaging recommendations identifying fragments of text in the medical reports that present recommendations about follow-up examinations.

22. The computing apparatus of claim 19, wherein the processor identifies the fragments of text by segmenting the text and stemming the segmented text by reducing the segmented text to its base/root grammatical form using a look-up table of standard English word endings and variants.

23. The computing apparatus of claim 20, wherein the processor, when executing the computer executable instructions: computes multiple-grams, each describing an occurrence of words in sequence within each segment and generates a vector of the multiple-grams, wherein the vector is a binary vector in which an occurrence of a phrase is assigned a value of one and a non-occurrence of the phrase is assigned a value of zero.

24. The computing apparatus of claim 23, wherein the processor, when executing the computer executable instructions: processes the vector with a mathematical function and generating a corresponding relevance score indicative of a likelihood that the sentence described by the vector contains a recommendation relevant to the follow-up examination.

25. The method of any of claims 20 to 24, wherein the processor, when executing the computer executable instructions: filters the identified follow-up imaging recommendations satisfying the predetermined relevance threshold based on at least one of a requested imaging procedure or an anatomy to be scanned to remove identified follow-up imaging recommendations that do not include the on at least one of a requested imaging procedure or an anatomy to be scanned.

26. The method of any of claims 20 to 25, wherein the processor, when executing the computer executable instructions: search text surrounding an identified follow-up imaging recommendation satisfying the predetermined relevance threshold for ontologically related terms, remove identified follow-up imaging recommendation in response to not finding any ontologically related terms, and confirm a relevance of the identified follow-up imaging recommendation in response to finding an ontologically related term.

27. The method of any of claims 20 to 25, wherein the processor, when executing the computer executable instructions: compare a clinical indication included on the imaging examination order with a context of an identified follow-up imaging recommendation satisfying the predetermined relevance threshold, remove identified follow-up imaging recommendation in response to not finding a match between the clinical indication and the context, and confirm a relevance of the identified follow-up imaging recommendation in response to finding a match between the clinical indication and the context.

28. A computer readable storage medium encoded with computer readable instructions, which, when executed by a processer, causes the processor to:
obtain, in electronic format, an imaging examination order for a follow-up imaging examination of a patient, wherein the imaging examination order at least includes one or more of a name of the patient or a unique identification of the patient;
retrieve electronically formatted prior medical reports of the patient from a data repository based on the one or more of the name of the patient or the unique identification of the patient;
identify follow-up imaging recommendations in the retrieved electronically formatted prior medical reports; and
visually present the identified follow-up imaging recommendations.
